(19) United States
(12) Patent Application Publication
(10) Pub. No.: US 2025/0251892 A1
(43) Pub. Date: Aug. 7, 2025

(54) METHOD FOR SWITCHING DISPLAY DEVICE TO PRESET MODE, AND ASSOCIATED DEVICES THEREOF

(71) Applicant: Realtek Semiconductor Corp., HsinChu (TW)

(72) Inventors: Yuh-Wey Lin, HsinChu (TW); Chien-Wei Chen, HsinChu (TW); Tzuo-Bo Lin, HsinChu (TW); Yu-Pin Chou, HsinChu (TW)

(73) Assignee: Realtek Semiconductor Corp., HsinChu (TW)

(21) Appl. No.: 19/035,780

(22) Filed: Jan. 23, 2025

(30) Foreign Application Priority Data
Feb. 5, 2024 (TW) 113104458

(51) Int. Cl. G06F 3/14

(52) U.S. Cl. CPC G06F 3/1423

(57) ABSTRACT

A method for switching a display device to a preset mode, and associated devices thereof, are provided. The method includes: utilizing a storage device to store identification information of a first preset device, identification information of a second preset device, and setting information corresponding to the preset mode; utilizing a third device to obtain identification information of a first device and identification information of a second device; and when the third device determines that the first device and the second device are, respectively, the first preset device and the second preset device, utilizing the third device to apply the setting information stored in the storage device to the display device. More particularly, in a system formed by a signal source device, a DisplayPort (DP) hub circuit and the display device, any of them can act as the third device.

### BACKGROUND OF THE INVENTION

### 1. Field of the Invention

The present invention is related to control of display devices, and more particularly, to a method for switching at least one display device to at least one preset mode, and to associated devices thereof, such as the display device and a DisplayPort (DP) hub circuit coupled to the display device.

### 2. Description of the Prior Art

In recent years, hybrid working modes have been widely adopted. Many companies have replaced personal (individual) seats with public (unassigned) seats, which can be used by different users at different times. A public seat typically has one or more display devices (e.g. monitors), and a user can connect their own laptop computer to these display devices, in order to project a working screen onto the display devices.

Different users may have different requirements for settings of the display devices, however, and the settings of the display devices on a public seat may be undesired. In the related art, a user needs to manually operate an on-screen display menu of a display device or adjust respective parameters of the display devices one by one via an additional application program. As the user will not remain in the same seat, the user may use a different display device every day, meaning the user must spend a lot of time in order to get familiar with the on-screen display menu of each display device. In addition, the laptop computer may be official equipment assigned by the company, and the user may not be allowed to install an application program developed for personalizing settings on the laptop computer.

Thus, there is a need for a novel method and associated devices, wherein an operation mode of a display device can be switched to a mode requested by a user without introducing any side effect or in a way that is less likely to introduce side effects.

### SUMMARY OF THE INVENTION

An objective of the present invention is to provide a method for switching at least one display device to at least one preset mode, and associated devices thereof, such as the display device and a DisplayPort (DP) hub circuit coupled to the display device, in order to solve the problem of requiring time to adjust setting(s) of a display device of a public seat.

At least one embodiment of the present invention provides a method for switching at least one display device to at least one preset mode. The method comprises: utilizing a storage device to store first preset identification information of a first preset device, second preset identification information of a second preset device, and setting information corresponding to the at least one preset mode; utilizing a third device to obtain first identification information of a first device from the first device and obtain second identification information of a second device from the second device; utilizing the third device to determine whether the first device and the second device are, respectively, the first preset device and the second preset device according to the first identification information, the second identification information, the first preset identification information and the second preset identification information, in order to generate a determination result; and in response to the determination result indicating that the first device and the second device are, respectively, the first preset device and the second preset device, utilizing the third device to apply the setting information stored in the storage device to the at least one display device, in order to switch the at least one display device to the at least one preset mode. More particularly, the third device represents one of a signal source device, a DisplayPort (DP) hub circuit and the at least one display device, the first device and the second device represent the other two of the signal source device, the DP hub circuit and the at least one display device, and the DP hub circuit is coupled between the signal source device and the at least one display device.

At least one embodiment of the present invention provides a DP hub circuit. The DP hub circuit comprises a controller, where the controller is coupled to a read only memory (ROM), and the controller is configured to control operations of the DP hub circuit according to a program code stored in the ROM. For example, the controller writes preset signal source identification information of a preset signal source device, preset display identification information of a preset display device, and setting information corresponding to at least one preset mode of the preset display device into a storage device. When a signal source device and at least one display device are coupled to the DP hub circuit, the controller obtains signal source identification information of the signal source device from the signal source device and obtains display identification information of the at least one display device from the at least one display device. The controller determines whether the signal source device and the at least one display device are, respectively, the preset signal source device and the preset display device according to the signal source identification information, the display identification information, the preset signal source identification information and the preset display identification information, in order to generate a determination result. When the determination result indicates that the signal source device and the at least one display device are, respectively, the preset signal source device and the preset display device, the controller applies the setting information stored in the storage device to the at least one display device, in order to switch the at least one display device to the at least one preset mode.

At least one embodiment of the present invention provides an image processor of a display device. The image processor comprises a controller, wherein the controller is coupled to a ROM, and the controller is configured to control operations of the image processor according to a program code stored in the ROM. For example, the controller writes preset signal source identification information of a preset signal source device, preset DP hub identification information of a preset DP hub circuit, and setting information corresponding to at least one preset mode of the display device into a storage device. When a signal source device and the display device are coupled to a DP hub circuit, the controller obtains signal source identification information of the signal source device from the signal source device and obtains DP hub identification information of the DP hub circuit from the DP hub circuit. The controller determines whether the signal source device and the DP hub circuit are, respectively, the preset signal source device and the preset DP hub circuit according to the signal source identification information, the DP hub identification information, the preset signal source identification information and the preset DP hub identification information, in order to generate a determination result. When the determination result indicates that the signal source device and the DP hub circuit are, respectively, the preset signal source device and the preset DP hub circuit, the controller applies the setting information stored in the storage device to the display device, in order to switch the display device to the at least one preset mode.

The method and the associated devices (e.g. the DP hub circuit and the image processor mentioned above) provided by the embodiments of the present invention make the signal source device, the DP hub circuit and the display device obtain identification information from one another, in order to automatically apply preset setting(s) to the display device when the signal source device, DP hub circuit and display device, which are already recorded, are connected. Thus, the user does not need to repeatedly adjust the setting(s) of the display device, thereby solving the problem of the related arts.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a working flow of a method for switching at least one display device to at least one preset mode according to an embodiment of the present invention.

FIG. 2 is a diagram illustrating a docking device acting as a host according to an embodiment of the present invention.

FIG. 3 is a diagram illustrating utilizing an external storage device coupled to a docking device to trigger a flow according to an embodiment of the present invention.

FIG. 4 is a diagram illustrating a signal source device acing as a host according to an embodiment of the present invention.

FIG. 5 is a diagram illustrating utilizing an external storage device coupled to the signal source device to trigger a flow according to an embodiment of the present invention.

FIG. 6 is a diagram illustrating a display device acting as a host according to an embodiment of the present invention.

FIG. 7 is a diagram illustrating utilizing an external storage device coupled to the display device to trigger a flow according to an embodiment of the present invention.

### DETAILED DESCRIPTION

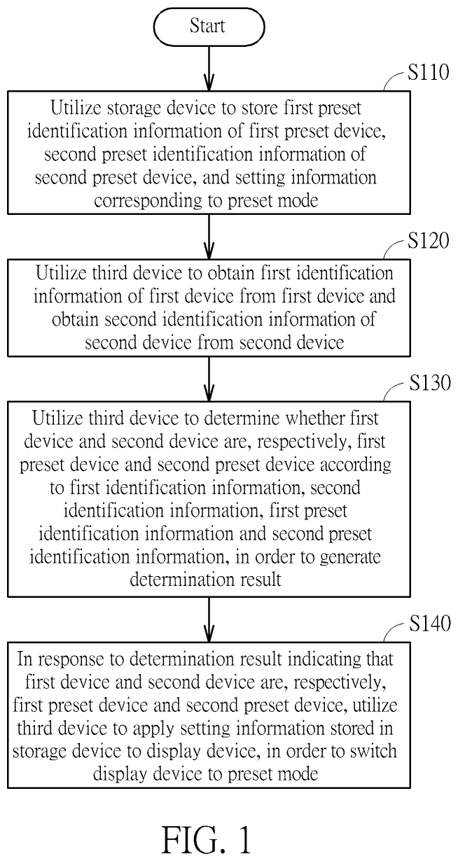

FIG. 1 is a diagram illustrating a working flow of a method for switching at least one display device (e.g. a monitor, a television or other image signal display devices) to at least one preset mode according to an embodiment of the present invention. More particularly, the method may be executed by a system consisting of a first device, a second device and a third device, where the third device may represent one of a signal source device (e.g. a laptop computer, a personal computer or other signal source devices), a DisplayPort (DP) hub circuit (e.g. a DP hub circuit built in a docking device, an adaptor, a dongle or other image signal relay processors) and the at least one display device, and the first device and the second device may represent the other two of the signal source device, the DP hub circuit and the at least one display device. In addition, the DP hub circuit is coupled between the signal source device and the at least one display device. It should be noted that the working flow shown in FIG. 1 is for illustrative purposes only, and is not meant to be a limitation of the present invention. For example, one or more steps may be added, deleted or modified in the working flow shown in FIG. 1. In addition, if a same result can be obtained, these steps do not have to be executed in the exact order shown in FIG. 1.

In Step S110, the system may utilize a storage device (e.g. an internal memory of the third device or an external memory coupled to the third device) to store first preset identification information of a first preset device, second preset identification information of a second preset device, and setting information corresponding to the at least one preset mode.

In Step S120, the system may utilize the third device to obtain first identification information of the first device from the first device and obtain second identification information of the second device from the second device.

In Step S130, the system may utilize the third device to determine whether the first device and the second device are, respectively, the first preset device and the second preset device according to the first identification information, the second identification information, the first preset identification information and the second preset identification information (e.g. determining whether the first identification information is identical to the first preset identification information and determining whether the second identification information is identical to the second preset identification information), in order to generate a determination result.

In Step S140, in response to the determination result indicating that the first device and the second device are, respectively, the first preset device and the second preset device, the system may utilize the third device to apply the setting information stored in the storage device to the at least one display device, in order to switch the at least one display device to the at least one preset mode.

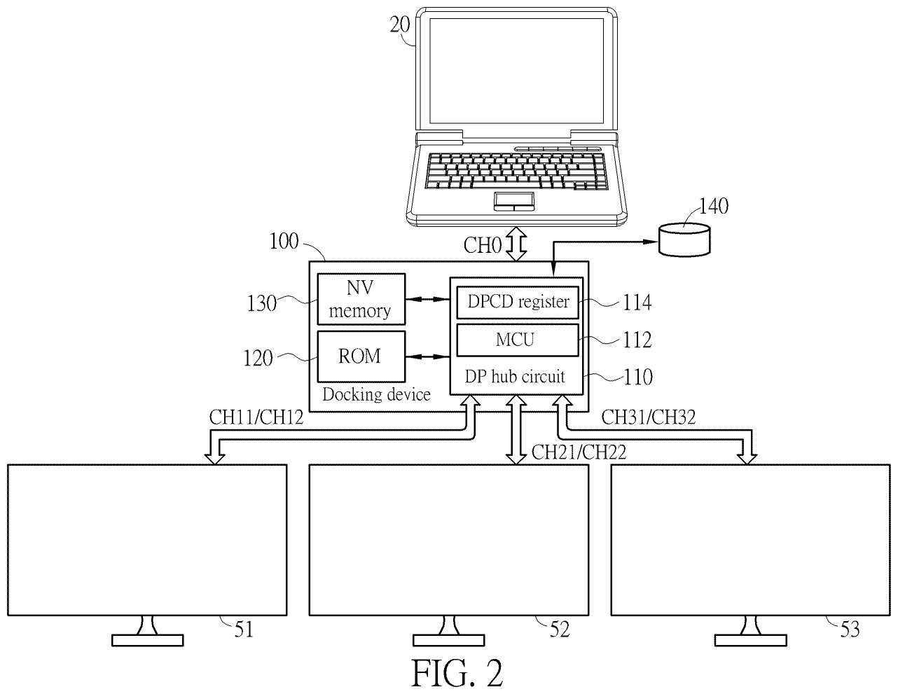

FIG. 2 is a diagram illustrating a docking device 100 acting as a host according to an embodiment of the present invention. As shown in FIG. 2, the docking device 100 may comprise a DP hub circuit 110, a read only memory (ROM) 120 and a non-volatile (NV) memory 130, where the ROM 120 and the NV memory 130 are coupled to the DP hub circuit 110. In some embodiments, the ROM 120 and/or the NV memory 130 may be implemented in the DP hub circuit 110, but the present invention is not limited thereto. In this embodiment, the DP hub circuit 110 may be an example of the third device, a signal source device 20 may be an example of the first device, and any of display devices 51, 52 and 53 may be an example of the second device.

As shown in FIG. 2, the DP hub circuit 110 may comprise a controller such as a microcontroller unit (MCU) 112 and a DP configuration data (DPCD) register 114, where the MCU 112 is coupled to the ROM 120, and is configured to control operations of the DP hub circuit 110 (e.g. various control schemes executed by the DP hub circuit 110 when acting as the host) according to a program code (e.g. firmware) stored in the ROM 120. For example, the MCU 112 may write preset signal source identification information (which may be an example of the first preset identification information) of a preset signal source device (which may be an example of the first preset device), preset display identification information (which may be an example of the second preset identification information) of a preset display device (which may be an example of the second preset device), and setting information corresponding to at least one preset mode of the preset display device into a storage device such as the NV memory 120. For example, a user may manually set setting information such as brightness, contrast or sharpness of any of each of the display devices 51, 52 and 53, and store results of the setting information as setting information corresponding to a preset mode. When the signal source device 20 and at least one display device (e.g. any or each of the display devices 51, 52 and 53, where the following is illustrated based on the display device 51 for brevity, and the rest may be deduced by analogy) are coupled to the DP hub circuit 110, the MCU 112 may obtain signal source identification information of the signal source device 20 from the signal source device 20 and obtain display identification information of the display device 51 from the display device 51. The MCU 112 may determine whether the signal source device 20 and the display device 51 are the preset signal source device and the preset display device according to the signal source identification information, the display identification information, the preset signal source identification information and the preset display identification information, in order to generate a determination result. When the determination result indicates that the signal source device 20 and the display device 51 are the preset signal source device and the preset display device (which means the setting information requested by a user owning the signal source device 20 is already stored in the NV memory 130), the MCU 112 may apply the setting information stored in the NV memory 130 to the display device 51, in order to switch the display device 51 to the at least one preset mode (i.e. the preset mode manually set by the user previously).

In detail, when the DP hub circuit 110 obtains and records the preset signal source identification information from the preset signal source device, the DP hub circuit 110 may utilize an auxiliary channel CHO to write the preset signal source identification information into the DPCD register 114 of the DP hub circuit 110 from the preset signal source device, for being written into the NV memory 130. Similarly, when the DP hub circuit 110 obtains the signal source identification information from the signal source device 20, the DP hub circuit 110 may utilize the auxiliary channel CHO to write the signal source identification information into the DPCD register 114 of the DP hub circuit 110 from the signal source device 20. In addition, when the DP hub circuit 110 obtains the preset display identification information from the preset display device, the

DP hub circuit 110 may utilize an inter-integrated circuit (I2C) over auxiliary channel (I2C-over-AUX channel) CH11 to obtain the preset display identification information from the preset display device. Similarly, when the DP hub circuit 110 obtains the display identification information from the display device 51, the DP hub circuit 110 may utilize the I2C-over-AUX channel CH11 to obtain the display identification information from the display device 51. In addition, when the DP hub circuit 110 stores the setting information corresponding to the preset mode into the NV memory 130, the DP hub circuit 110 may utilize a display data channel command interface (DDCCI) CH12 to obtain the setting information from the display device 51, and the DP hub circuit 110 may write the setting information into the NV memory 130.

In this embodiment, the signal source identification information may comprise information of a source organizational unique identifier (OUI), a source device identification string (DIS), a source specific field (SSF) or other available information of the signal source device 20, but the present invention is not limited thereto. In addition, the display identification information may comprise extended display identification data (EDID) or other available information of the display device 51, but the present invention is not limited thereto.

In some embodiments, the at least one preset mode may comprise multiple preset modes. For example, a user may set multiple preset modes (e.g. a video work mode and a documentation work mode) in advance, and more particularly, may set multiple sets of setting information respectively corresponding to the multiple preset modes. In this embodiment, the user may utilize a physical button 140 coupled to the docking device 100 (e.g. the DP hub circuit 110 therein) to control the display device 51 to be switched among the multiple preset modes. In practice, the DP hub circuit 110 may select a set of setting information to be applied to the display device 51 from the multiple sets of setting information according to operations of the physical button 140, to enable the user to control the display device 51 to be switched among the multiple preset modes via the operations of the physical button 140.

Deduced by analogy, communication between the DP hub circuit 112 and the display device 52 may be performed via an I2C-over-Aux channel CH21 and a DDCCI CH22, and communication between the DP hub circuit 112 and the display device 53 may be performed via an I2C-over-Aux channel CH31 and a DDCCI CH32, where the control of the display device 51 performed by the DP hub circuit 110 may be applied to the control of the display device 52 or 53 performed by the DP hub circuit 110; related details will not be repeated here for brevity. In addition, the DP hub circuit 110 may apply the setting information to the display devices 51, 52 and 53 (e.g. applying same setting information to the display devices 51, 52 and 53), to make all of the display devices 51, 52 and 53 operate in the preset mode (e.g. all of the display devices 51, 52 and 53 operate in a same mode and therefore have the same brightness, contrast and/or sharpness). In some embodiments, the display devices 51, 52 and 53 may be products of different manufacturers or different series of products of a same manufacturer. The DP hub circuit 110 still can apply setting information defined in public regulations (e.g. the brightness and the contrast) to the display devices 51, 52 and 53 according to a monitor control command set (MCCS) standard, but the present invention is not limited thereto.

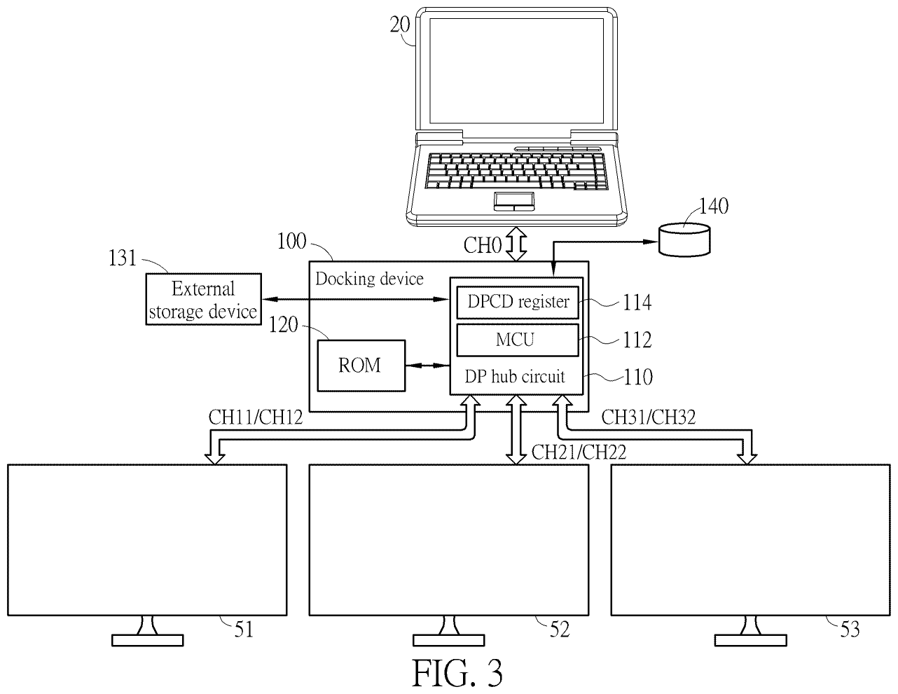

FIG. 3 is a diagram illustrating utilizing an external storage device 131 coupled to the docking device 100 (more particularly, the DP hub circuit 110 therein) to trigger a flow according to an embodiment of the present invention, where the external storage device 131 may be an external storage device equipped with a universal serial bus (USB) interface or a memory card equipped with a radio frequency identification (RFID) function such as a badge card. In this embodiment, the external storage device 131 may be a replacement scheme of the NV memory 130, and more particularly, the external storage device 131 may be configured to store all information stored in the NV memory 130 of the embodiment of FIG. 2. In addition, when the docking device 100 (more particularly, the DP hub circuit 110 therein) detects that the external device 131 is plugged into the docking device 100, the DP hub circuit 110 may trigger the flow from Step S120 to Step S140 shown in FIG. 1, but the present invention is not limited thereto.

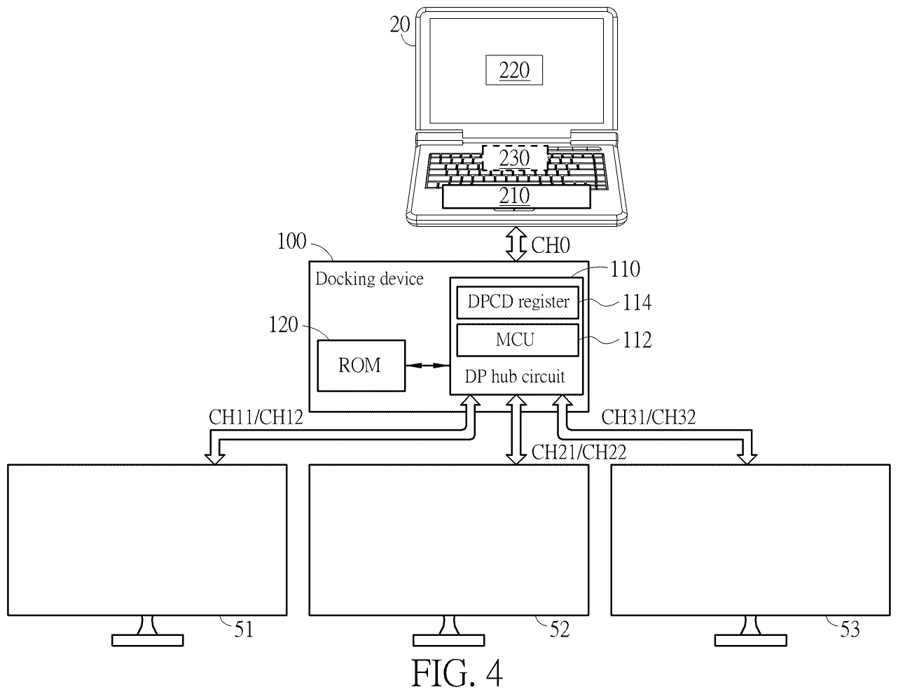

FIG. 4 is a diagram illustrating the signal source device 20 acing as a host according to an embodiment of the present invention, where the signal source device 20 may comprise an NV memory 210, and the signal source device 20 may execute an application program 220 to control the working flow shown in FIG. 1. In this embodiment, the signal source device 20 may be an example of the third device, the DP hub circuit 110 may be an example of the first device, and any of the display devices 51, 52 and 53 may be an example of the second device. In this embodiment, the signal source device 20 may write preset DP hub identification information (which may be an example of the first preset identification information) of a preset DP hub circuit (which may be an example of the first preset device), preset display identification information (which may be an example of the second preset identification information) of a preset display device (which may be an example of the second preset device), and setting information (e.g. the setting information obtained by a manual setting performed by the user mentioned above) corresponding to at least one preset mode of the preset display device into a storage device such as the NV memory 210. When the signal source device 20 and at least one display device (e.g. any or each of the display devices 51, 52 and 53, where the following is illustrated based on the display device 51 for brevity, and the rest may be deduced by analogy) are coupled to the DP hub circuit 110, the signal source device 20 (more particularly, an application program 220 running thereon) may obtain DP hub identification information of the DP hub circuit 110 from the DP hub circuit 110 and obtain display identification information of the display device 51 from the display device 51. The signal source device 20 (more particularly, the application program 220 running thereon) may determine whether the DP hub circuit 110 and the display device 51 are the preset DP hub circuit and the preset display device according to the DP hub identification information, the display identification information, the preset DP hub identification information and the preset display identification information, in order to generate a determination result. When the determination result indicates that the DP hub circuit 110 and the display device 51 are the preset DP hub circuit and the preset display device, respectively (which means the setting information requested by the user owning the signal source device 20 is already stored in the NV memory 210), the signal source device 20 may apply the setting information stored in the NV memory 210 to the display device 51 via the docking device 100, to switch the display device 51 to the at least one preset mode (i.e. the preset mode manually set by the user previously).

In detail, when the signal source device 20 obtains and records the preset DP hub identification information from the preset DP hub circuit, the signal source device 20 may utilize the auxiliary channel CHO to obtain the preset DP hub identification information from a DPCD register of the preset DP hub circuit, for being written into the NV memory 210. Similarly, when the signal source device 20 obtains the DP hub identification information from the DP hub circuit 110, the signal source device 20 may utilize the auxiliary channel CHO to obtain the DP hub identification information from the DPCD register 114 of the DP hub circuit 110. In addition, when the signal source device 20 obtains and records the preset display identification information from the preset display device, the signal source device 20 may control the preset DP hub circuit to utilize the I2C-over-Aux channel CH11 to transmit the preset display identification information to the preset DP hub circuit from the preset display device, in order to transmit the preset display identification information to the signal source device 20 via the preset DP hub circuit. Similarly, when the signal source device 20 obtains the display identification information from the display device 51, the signal source device 20 may control the DP hub circuit 110 to utilize the I2C-over-Aux channel CH11 to transmit the display identification information to the DP hub circuit 110 from the display device 51, in order to transmit the display identification information to the signal source device 20 via the DP hub circuit 110. In addition, when the signal source device 20 stores the setting information corresponding to the preset mode into the NV memory 210 via the DP hub circuit 110, the signal source device 20 may control the DP hub circuit 110 to utilize the DDCCI CH12 for transmitting the setting information to the DP hub circuit 110 from the display device 51, in order to obtain the setting information via the DP hub circuit 110, and the signal source device 20 may write the setting information into the NV memory 210.

In this embodiment, the DP hub identification information may comprise a DP hub OUI, a source DIS or other available information of the DP hub circuit 100, but the present invention is not limited thereto. In addition, the display identification information may comprise EDID or other available information of the display device 51, but the present invention is not limited thereto.

In addition, a user may set multiple sets of setting information respectively corresponding to multiple preset modes (e.g. the video work mode and the documentation work mode) in advance. In this embodiment, the user may utilize operations of a hot key 230 (e.g. one or more sets of preset key combinations) to control the display device 50 to be switched among the multiple preset modes. In particular, the DP hub circuit 110 may select a set of setting information to be applied to the display device 51 from the multiple sets of setting information according to the operations of the hot key 230, to enable the user to control the display device 51 to be switched among the multiple preset modes via the operations of the hot key 230. In addition, the signal source device 20 may control the DP hub circuit 110 to apply the setting information to the display devices 51, 52 and 53 (e.g. applying same setting information to the display devices 51, 52 and 53), to make all of the display devices 51, 52 and 53 operate in the preset mode (e.g. all of the display devices 51, 52 and 53 operate in a same mode and have the same brightness, contrast and/or sharpness).

It should be noted that the only difference between the embodiment of FIG. 4 and the previous embodiment (e.g. the embodiment of FIG. 2) is that the devices acting as the host are different. Those skilled in this art should understand how to apply other operations to the embodiment of FIG. 4 according to related descriptions of the embodiment of FIG. 2; related details are omitted here for brevity.

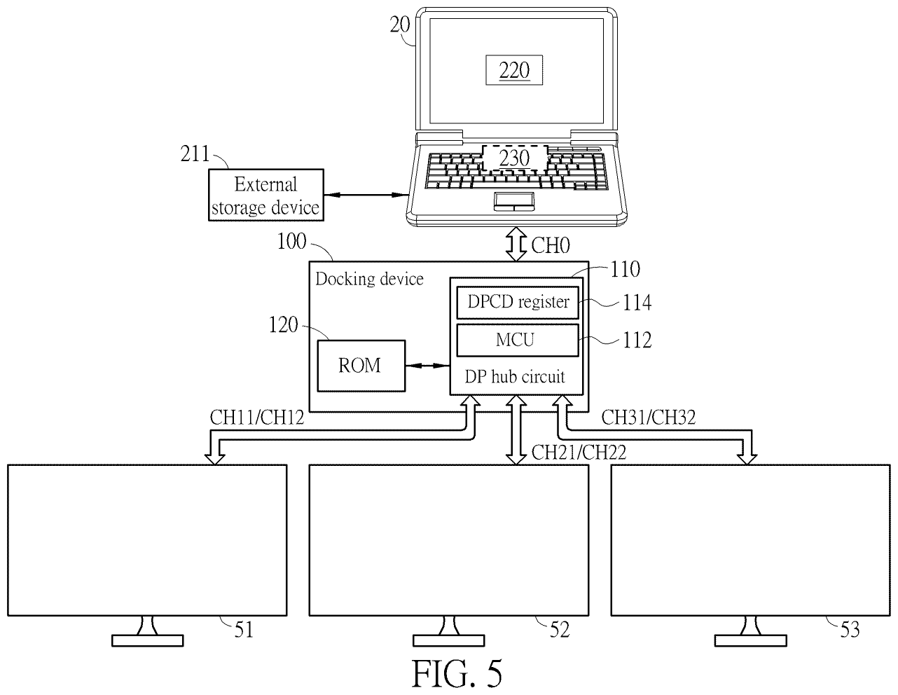

FIG. 5 is a diagram illustrating utilizing an external storage device 211 coupled to the signal source device 20 to trigger a flow according to an embodiment of the present invention, where the external storage device 211 may be an external storage device equipped with an USB interface or a memory card equipped with a RFID function such as a badge card. In this embodiment, the external storage device 211 may be a replacement scheme of the NV memory 210, and more particularly, the external storage device 211 may be configured to store all information stored in the NV memory 210 of the embodiment of FIG. 4. In addition, when the signal source device 20 detects that the external device 211 is plugged into the signal source device 20, the signal source device 20 may trigger the flow from Step S120 to Step S140 shown in FIG. 1, but the present invention is not limited thereto.

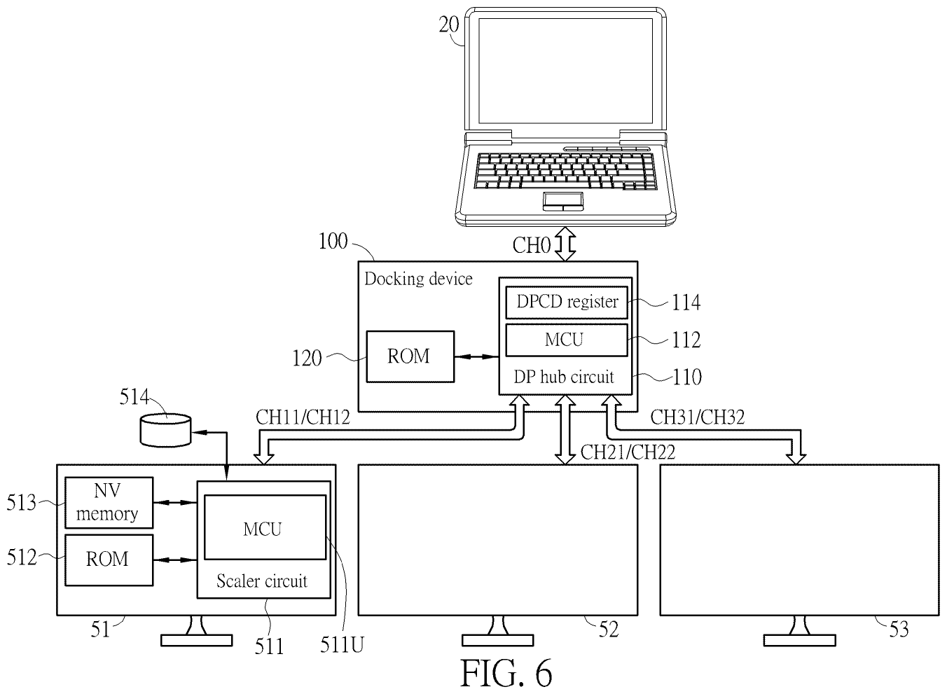

FIG. 6 is a diagram illustrating the display device 51 acting as a host according to an embodiment of the present invention. As shown in FIG. 6, the display device 51 may comprise an image processor such as a scaler circuit 511, a ROM 512 and a NV memory 513, where the ROM 512 and the NV memory 513 are coupled to the scaler circuit 511. In some embodiments, the ROM 512 and/or the NV memory 513 may be implemented in the scaler circuit 511, but the present invention is not limited thereto. In this embodiment, the scaler circuit 511 may be an example of the third device, the signal source device 20 may be an example of the first device, and the DP hub circuit 110 may be an example of the second device.

As shown in FIG. 6, the scaler circuit 511 may comprise a controller such as an MCU 511U, where the MCU 511U is coupled to the ROM 512, and is configured to control operations of the scaler circuit 511 (e.g. various control schemes executed by the scaler circuit 511 when acting as the host) according to a program code (e.g. firmware) stored in the ROM 512. For example, the MCU 511U may write preset signal source identification information (which may be an example of the first preset identification information) of a preset signal source device (which may be an example of the first preset device), preset DP hub identification information (which may be an example of the second preset identification information) of a preset DP hub circuit (which may be an example of the second preset device), and setting information (e.g. the setting information obtained by a manual setting performed by the user mentioned above) corresponding to at least one preset mode of the display device 51 into a storage device such as the NV memory 513. When the signal source device 20 and the display device 51 are coupled to the DP hub circuit 110, the MCU 511U may obtain signal source identification information of the signal source device 20 from the signal source device 20 and obtain DP hub identification information of the DP hub circuit 110 from the DP hub circuit 110. The MCU 511U may determine whether the signal source device 20 and the DP hub circuit 110 are, respectively, the preset signal source device and the preset DP hub circuit according to the signal source identification information, the DP hub identification information, the preset signal source identification information and the preset DP hub identification information, in order to generate a determination result. When the determination result indicates that the signal source device 20 and the DP hub circuit 110 are, respectively, the preset signal source device and the preset DP hub circuit, respectively, the MCU 511U may apply the setting information stored in the NV memory 513 to the display device 50, in order to switch the display device 51 to the at least one preset mode (i.e. the preset mode manually set by the user previously).

In detail, when the display device 51 (more particularly, the scaler circuit 511 therein) obtains and records the preset signal source identification information from the preset signal source device, the display device 51 may control the DP hub circuit 51 to utilize the auxiliary channel CHO to write the preset signal source identification information into a DPCD register of the preset DP hub circuit from the preset signal source device, to allow the display device 51 to obtain the preset signal source identification information from the DPCD register of the preset DP hub circuit. Similarly, when the display device 51 (more particularly, the scaler circuit 511 therein) obtains and records the signal source identification information, the display device 51 may control the DP hub circuit 110 to utilize the auxiliary channel CHO to write the signal source identification information into the DPCD register 114 of the DP hub circuit 110 from the signal source device 20, to allow the display device 51 to obtain the signal source identification information from the DPCD register 114. In addition, when the display device 51 (more particularly, the scaler circuit 511 therein) obtains and records the preset DP hub identification information from the preset DP hub circuit, the display device 51 may utilize the I2C-over-Aux channel CH11 to obtain the preset DP hub identification information from the DPCD register of the preset DP hub circuit. Similarly, when the display device 51 (more particularly, the scaler circuit 511 therein) obtains the DP hub identification information from the DP hub circuit 110, the display device 51 may utilize the I2C-over-Aux channel CH11 to obtain the DP hub identification information from the DPCD register 114 of the DP hub circuit 110.

In addition, a user may set multiple sets of setting information respectively corresponding to multiple preset modes (e.g. the video work mode and the documentation work mode) in advance. In this embodiment, the user may utilize a physical button 514 coupled to the display device 51 (e.g. the scaler circuit 511 therein) to control the display device 51 to be switched among the multiple preset modes. In particular, the scaler circuit 511 may select a set of setting information to be applied to the display device 51 from the multiple sets of setting information according to operations of the physical button 514, to enable the user to control the display device 51 to be switched among the multiple preset modes via the operations of the physical button 514. In addition, the display device 51 may control the DP hub circuit 110 to further apply the setting information to the display devices 52 and 53 (e.g. applying same setting information to the display devices 51, 52 and 53), to make all of the display devices 51, 52 and 53 operate in the preset mode (e.g. all of the display devices 51, 52 and 53 operate in a same mode and have the same brightness, contrast and/or sharpness).

It should be noted that the only difference between the embodiment of FIG. 4 and the previous embodiment (e.g. the embodiment of FIG. 2 or the embodiment of FIG. 4) is that the devices acting as the host are different. Those skilled in this art should understand how to apply other operations to the embodiment of FIG. 6 according to related descriptions of the embodiment of FIG. 2 or FIG. 4; related details are omitted here for brevity.

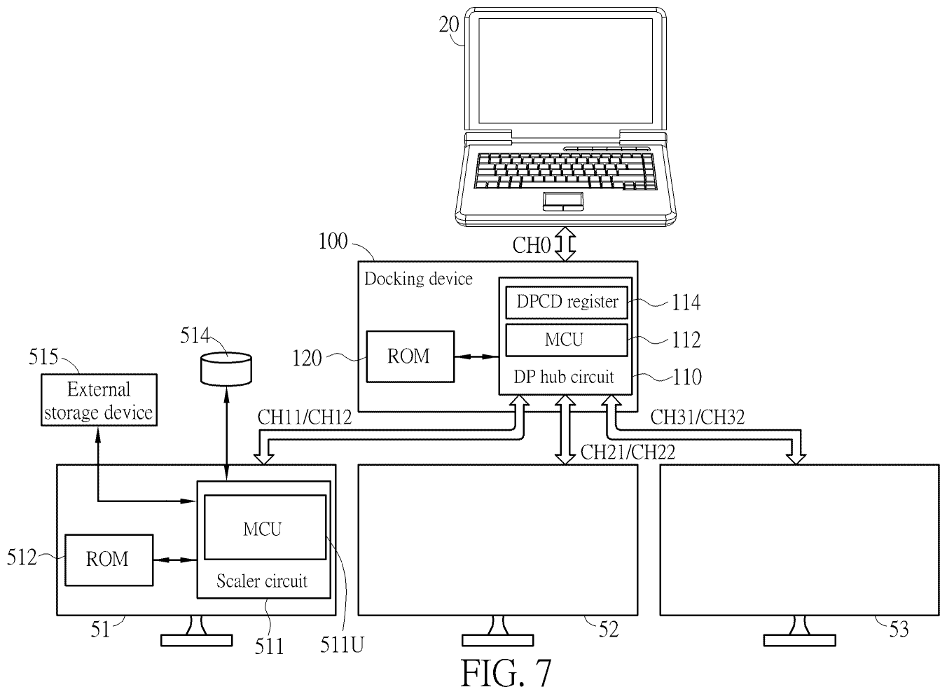

FIG. 7 is a diagram illustrating utilizing an external storage 515 device coupled to the display device 51 to trigger a flow according to an embodiment of the present invention, where the external storage device 515 may be an external storage device equipped with a USB interface or a memory card equipped with an RFID function such as a badge card. In this embodiment, the external storage device 515 may be a replacement scheme of the NV memory 513, and more particularly, the external storage device 515 may be configured to store all information stored in the NV memory 513 of the embodiment of FIG. 6. In addition, when the display device 51 detects that the external device 515 is plugged into the display device 51, the display device 51 may trigger the flow from Step S120 to Step S140 shown in FIG. 1, but the present invention is not limited thereto.

To summarize, the method and the associated devices of the present invention can enable the devices to obtain identification information from one another, in order to automatically apply a display setting which is set in advance to the display device when the identified devices are linked, thereby preventing the user from having to repeatedly manually adjust the display setting of the display device. The embodiments of the present invention will not greatly increase additional costs. Thus, the present invention can solve the problem of the related arts without introducing any side effect or in a way that is less likely to introduce side effects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for switching at least one display device to at least one preset mode, comprising:
utilizing a storage device to store first preset identification information of a first preset device, second preset identification information of a second preset device, and setting information corresponding to the at least one preset mode;
utilizing a third device to obtain first identification information of a first device from the first device and obtain second identification information of a second device from the second device;
utilizing the third device to determine whether the first device and the second device are, respectively, the first preset device and the second preset device according to the first identification information, the second identification information, the first preset identification information and the second preset identification information, in order to generate a determination result; and
in response to the determination result indicating that the first device and the second device are, respectively, the first preset device and the second preset device, utilizing the third device to apply the setting information stored in the storage device to the at least one display device, in order to switch the at least one display device to the at least one preset mode;
wherein the third device represents one of a signal source device, a DisplayPort (DP) hub circuit and the at least one display device, the first device and the second device represent the other two of the signal source device, the DP hub circuit and the at least one display device, and the DP hub circuit is coupled between the signal source device and the at least one display device.

2. The method of claim 1, wherein the third device represents the DP hub circuit, and the first device and the second device represent the signal source device and the at least one display device, respectively.

3. The method of claim 2, wherein an operation of utilizing the third device to obtain the first identification information of the first device from the first device comprises:
utilizing an auxiliary channel to write the first identification information into a DP configuration data (DPCD) register of the DP hub circuit from the signal source device.

4. The method of claim 2, wherein an operation of utilizing the third device to obtain the second identification information of the second device from the second device comprises:
utilizing an inter-integrated circuit (I2C) over auxiliary channel (I2C-over-AUX channel) to transmit the second identification information to the at least one display device from the DP hub circuit.

5. The method of claim 2, wherein an operation of utilizing the storage device to store the setting information corresponding to the at least one preset mode comprises:
utilizing a display data channel command interface (DDCCI) to transmit the setting information to the DP hub circuit from the at least one display device, in order to write the setting information into the storage device via the DP hub circuit.

6. The method of claim 2, wherein the first identification information comprises information of an organizational unique identifier (OUI), a device identification string (DIS) or a source specific field (SSF) of the signal source device.

7. The method of claim 2, wherein the second identification information comprises extended display identification data (EDID) of the at least one display device.

8. The method of claim 1, wherein the third device represents the signal source device, and the first device and the second device represent the DP hub circuit and the at least one display device, respectively.

9. The method of claim 8, wherein an operation of utilizing the third device to obtain the first identification information of the first device from the first device comprises:
utilizing an auxiliary channel to transmit the first identification information to the signal source device from a DP configuration data (DPCD) register of the DP hub circuit.

10. The method of claim 8, wherein an operation of utilizing the third device to obtain the second identification information of the second device from the second device comprises:
utilizing an inter-integrated circuit (I2C) over auxiliary channel (I2C-over-AUX channel) to transmit the second identification information to the DP hub circuit from the at least one display device, to transmit the second identification information to the signal source device via the DP hub circuit.

11. The method of claim 8, wherein an operation of utilizing the storage device to store the setting information corresponding to the at least one preset mode comprises:
utilizing a display data channel command interface (DDCCI) to transmit the setting information to the DP hub circuit from the at least one display device, in order to transmit the setting information to the signal source device via the DP hub circuit; and
utilizing the signal source device to write the setting information into the storage.

12. The method of claim 1, wherein the third device represent the at least one display device, and the first device and the second device represent the signal source device and the DP hub circuit, respectively.

13. The method of claim 12, wherein an operation of utilizing the third device to obtain the first identification information of the first device from the first device comprises:
utilizing an auxiliary channel to write the first identification information into a DP configuration data (DPCD) register of the DP hub circuit from the signal source device, in order to make the at least one display device to obtain the first identification information from the DPCD register.

14. The method of claim 12, wherein an operation of utilizing the third device to obtain the second identification information of the second device from the second device comprises:
utilizing an inter-integrated circuit (I2C) over auxiliary channel (I2C-over-AUX channel) to transmit the second identification information to the at least one display device from a DP configuration data (DPCD) register of the DP hub circuit.

15. The method of claim 1, wherein the setting information comprises brightness, contrast or sharpness of the at least one display device.

16. The method of claim 1, wherein the at least one preset mode comprises multiple preset modes, the setting information comprise multiple sets of setting information respectively corresponding to the multiple preset modes, and an operation of utilizing the third device to apply the setting information stored in the storage device to the at least one display device for switching the at least one display device to the at least one preset mode comprises:
selecting a set of setting information to be applied to the at least one display device from the multiple sets of setting information according to operations of a physical button of the third device or a hot key of the third device, to enable a user to control the at least one display device to switch among the multiple preset modes via the operations of the physical button or the hot key.

17. The method of claim 1, wherein the at least one display device comprises multiple display devices, and an operation of utilizing the third device to apply the setting information stored in the storage device to the at least one display device to switch the at least one display device to the at least one preset mode comprises:
applying the setting information to the multiple display devices, in order to make all of the multiple display devices operate in the at least one preset mode.

18. The method of claim 1, wherein the storage device is an external storage device equipped with a universal serial bus (USB) interface or a memory card equipped with a wireless radio frequency (RF) identification (RFID) function.

19. A DisplayPort (DP) hub circuit, comprising:
a controller, coupled to a read only memory (ROM), configured to control operations of the DP hub circuit according to a program code stored in the ROM;
wherein:
the controller writes preset signal source identification information of a preset signal source device, preset display identification information of a preset display device, and setting information corresponding to at least one preset mode of the preset display device into a storage device;
when a signal source device and at least one display device are coupled to the DP hub circuit, the controller obtains signal source identification information of the signal source device from the signal source device and obtains display identification information of the at least one display device from the at least one display device;
the controller determines whether the signal source device and the at least one display device are, respectively, the preset signal source device and the preset display device according to the signal source identification information, the display identification information, the preset signal source identification information and the preset display identification information, in order to generate a determination result; and
when the determination result indicates that the signal source device and the at least one display device are, respectively, the preset signal source device and the preset display device, the controller applies the setting information stored in the storage device to the at least one display device, in order to switch the at least one display device to the at least one preset mode.

20. An image processor of a display device, comprising:
a controller, coupled to a read only memory (ROM), configured to control operations of the image processor according to a program code stored in the ROM;
wherein:
the controller writes preset signal source identification information of a preset signal source device, preset DisplayPort (DP) hub identification information of a preset DP hub circuit, and setting information corresponding to at least one preset mode of the display device into a storage device;
when a signal source device and the display device are coupled to a DP hub circuit, the controller obtains signal source identification information of the signal source device from the signal source device and obtains DP hub identification information of the DP hub circuit from the DP hub circuit;
the controller determines whether the signal source device and the DP hub circuit are, respectively, the preset signal source device and the preset DP hub circuit according to the signal source identification information, the DP hub identification information, the preset signal source identification information and the preset DP hub identification information, in order to generate a determination result; and
when the determination result indicates that the signal source device and the DP hub circuit are, respectively, the preset signal source device and the preset DP hub circuit, the controller applies the setting information stored in the storage device to the display device, in order to switch the display device to the at least one preset mode.
